(19) United States
(12) Patent Application Publication
(10) Pub. No.: US 2012/0318934 A1
(43) Pub. Date: Dec. 20, 2012

(54) Multiple vertical clevis hangers

(76) Inventor: D. Bryan Thomas, Spring, TX (US)

(21) Appl. No.: 13/134,761

(22) Filed: Jun. 16, 2011

(51) Int. Cl. F16L 3/22

(52) U.S. Cl. 248/58

(57) ABSTRACT

A multiple clevis hanger comprises an inverted, generally U-shaped upper hanger member; a plurality of generally U-shaped lower hanger members of different lengths, wherein shorter lower hanger members are positioned within longer lower hanger members; and a fastener to connect the upper hanger member and the plurality of lower hanger members.

### BACKGROUND OF THE INVENTION

1. Field of the Invention

This invention relates generally to the field of hangers for supporting pipes and conduits. More particularly, the invention relates to the field of clevis hangers.

2. Description of the Related Art

In the plumbing, electrical, and mechanical industries, elongated members, such as pipes, conduits, and cables, are supported by fixtures attached to the ceiling, beams, or other overhead supports. Although many types of support fixtures are employed, one of the most commonly used is a clevis hanger. This common use is due to the affordability, simplicity, and ease of use of clevis hangers.

Typically, support fixtures such clevis hangers are designed to support one pipe each. Thus, each pipe is supported by its own set of support fixtures. It would be more efficient and more economical to be able to support more than one pipe from each support fixture. It would also be easier to install the pipes. For example, it would be possible to carry both hot and cold running water supply lines on one set of hangers.

Several types of support fixtures have been proposed in the past to support two, or even more, pipes or conduits. Multiple hook-shaped supports suspended from rods are described in U.S. Pat. No. 5,385,320 (Ismert et al.), U.S. Pat. No. 5,573,210 (Hendrix et al.), U.S. Pat. No. 6,354,542 B1 (Meyer et al.), and U.S. Pat. No. 7,780,122 B1 (Herbers). Concave hanger brackets shaped to hold multiple pipes and suspended from rods or the ceiling are described in U.S. Pat. No. 4,245,806 (Vangreen) and U.S. Pat. No. 4,524,936 (Hurtubise).

Multiple flexible straps suspended from a rod are described in U.S. Pat. No. 5,890,683 (DePietro). Multiple clamp-like hangers suspended from vertical and horizontal supports are described in U.S. Pat. No. 5,261,633 (Mastro), U.S. Pat. No. 7,195,038 B2 (Friedline et al.) and U.S. Pat. No. 7,543,606 B2 (Friedline et al.). Multiple brackets attached to horizontal supports attached to joists or the ceiling are described in U.S. Pat. No. 5,593,115 (Lewis), U.S. Pat. No. 6,296,211 B1 (Snyder), U.S. Pat. No. 6, 896,226 B2 (Heath), and U.S. Pat. No. 7,654,043 B2 (Heath).

A double bracket-within-a-bracket pipe hanger is described in U.S. Pat. No. 6,505,796 B1 (Roth). In the Roth patent, a smaller triangular-shaped bracket is mounted within a larger triangular-shaped bracket.

Horizontal double clevis hangers are described in US 2009/0321587 A1 (Thackeray). In the Thackeray patent, two lower clevis brackets of different lengths are mounted side-by-side under an upper support yoke bracket. The support yoke bracket has been specially expanded in width to accommodate the two clevis brackets.

Thus, a need exists for a clevis hanger that can support more than one pipe or conduit that is economical to produce and efficient to use.

### BRIEF SUMMARY OF THE INVENTION

The invention is a multiple clevis hanger, comprising an inverted, generally U-shaped upper hanger member; a plurality of generally U-shaped lower hanger members of different lengths, wherein shorter lower hanger members are positioned within longer lower hanger members; and a fastener to connect the upper hanger member and the plurality of lower hanger members.

### BRIEF DESCRIPTION OF THE DRAWINGS

The invention and its advantages may be more easily understood by reference to the following detailed description and the attached drawings, in which:

FIG. 1 is a side view of an embodiment of the invention as a double clevis hanger;

FIG. 2 is an exploded side view of an embodiment of the invention shown in FIG. 1;

FIG. 3 is an environmental side view of an embodiment of the invention shown in FIG. 1;

FIG. 4 is a side view of another embodiment of the invention as a multiple clevis hanger; and

FIG. 5 is a side view of an alternative embodiment of the invention as a double clevis hanger.

While the invention will be described in connection with its preferred embodiments, it will be understood that the invention is not limited to these. On the contrary, the invention is intended to cover all alternatives, modifications, and equivalents that may be included within the scope of the invention, as defined by the appended claims.

### DETAILED DESCRIPTION OF THE INVENTION

The invention is a multiple clevis hanger for supporting elongated conduits from a ceiling, upper beams, or any type of upper support. Here elongated conduits is intended in the most general sense, so as to include, but not be restricted to, electrical conduits, cables, and pipes. The pipes can be carrying all types of water, liquids, steam, and any other appropriate fluid. The pipes could be, for example, flexible or either insulated or uninsulated.

The multiple clevis hanger of the invention has a plurality of U-shaped lower hanger members. The first lower hanger member carries a pipe or conduit in a manner similar to conventional single clevis hangers. The additional lower hanger members extend successively farther down than the first lower hanger member to accommodate additional conduits.

The plurality of lower hanger members are formed from straps of metal bent into a generally U-shaped hanger. The straps of metal can comprise materials including, but not limited to, black iron, galvanized iron, and iron covered by galvanized isolation tape. In the case of supporting copper pipes, the straps of metal should preferably be copper-coated.

Each lower hanger member has a pair of generally parallel arms extending generally vertically upward from the bottom. An upper hanger member has a pair of arms extending downward to each arm of the upper hanger member. Each of the arms of the lower hanger members and each of the lower portions of the upper hanger member has an opening to accommodate a bolt that holds both members together. The openings are in horizontal alignment with one another when the upper and lower hanger members are connected. A fastener (bolt) extends through the openings to connect the upper and lower hanger members.

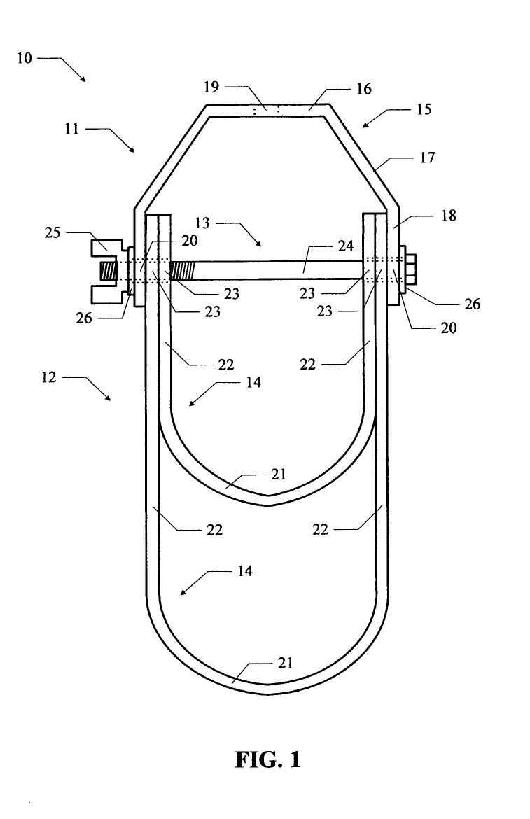

FIG. 1 is a side view of an embodiment of the invention as a double clevis hanger. The invention is a multiple vertical conduit hanger, generally designated by the reference numeral 10. The embodiment illustrated in FIG. 1 is a double clevis hanger, but the number of hangers is not intended to be a limitation of the invention.

The multiple vertical conduit hanger 10 generally comprises an upper hanger assembly 11, a lower hanger assembly 12, and a fastener 13 connecting the upper hanger assembly 11 to the lower hanger assembly 12. The lower hanger assembly 12 further comprises a plurality of lower hanger members 14.

The upper hanger assembly 11 comprises an inverted, generally U-shaped upper hanger member 15. The upper hanger member 15, in an exemplary embodiment illustrated here, typically comprises a upper portion 16, a pair of upper arms 17, and a pair of lower arms 18. The pair of upper arms 17 of the upper hanger member 15 extend generally downward from the upper portion 16. The pair of lower arms 18 of the upper hanger member 15 extend generally vertically downward from the pair of upper arms 17.

The upper portion 16 has a centrally located aperture 19. Each of the pair of lower arms 18 has an aperture 20 located near its lower end, the apertures 20 horizontally aligned with each other.

Each of the lower hanger members 14 comprises a generally U-shaped member with a lower portion 21 and a pair of upper arms 22. The lower portion 21 is generally semi-circular-shaped. In preferred embodiments, the invention is used for conduits with sizes of one half inch to two inches, both insulated and non-insulated. Thus, the lower portion 21 of the lower hanger members 14 would be appropriately sized to accommodate the conduit. The pair of upper arms 22 of the lower hanger members 14 extend generally vertically upward from the lower portion 21.

Each of the pair of upper arms 22 has an aperture 23 located near its upper end, the apertures 23 horizontally aligned with each other. Each of the lower arms 17 of the upper hanger member 15 and the upper arms 22 of the plurality of lower hanger members 14 are designed to be positioned with their ends aligned beside each other. In this position, each of the apertures 20 in the lower arms 17 of the upper hanger member 15 and the apertures 23 in the upper arms 22 of the plurality of lower hanger members 14 are designed to be horizontally aligned with each other so that the lower arms 17 and the upper arms 22 may be connected by the fastener 13 inserted through the apertures 20, 23.

The fastener 13 may be any appropriate kind of connecting device. Typically, the fastener 13 is a bolt and nut (possibly with washers), known as a clevis bolt. However, the type of fastener 13 employed is not intended to be a limitation of the invention. In the preferred embodiment shown in FIG. 1, the fastener 13 is a bolt 24 secured with wing nuts 25 and nylon bushings 26 to make this process easier, faster, and eliminate the need for extra tools. In an alternative embodiment, a wing nut 25 with a lock washer (not shown) can be substituted.

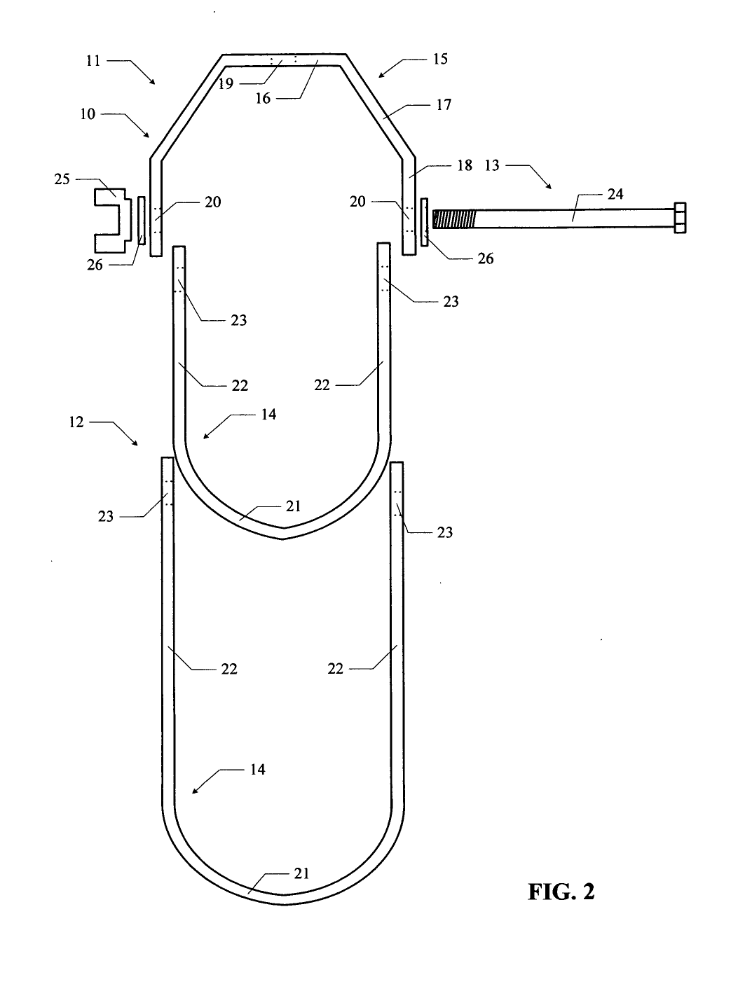

FIG. 2 is an exploded side view of the embodiment of the invention shown in FIG. 1. FIG. 2 shows the upper hanger assembly 11, the lower hanger assembly 12, and the fastener 13 of the multiple vertical conduit hanger 10, along with the plurality of lower hanger members 14 and all the other features of the embodiment of the invention shown in FIG. 1.

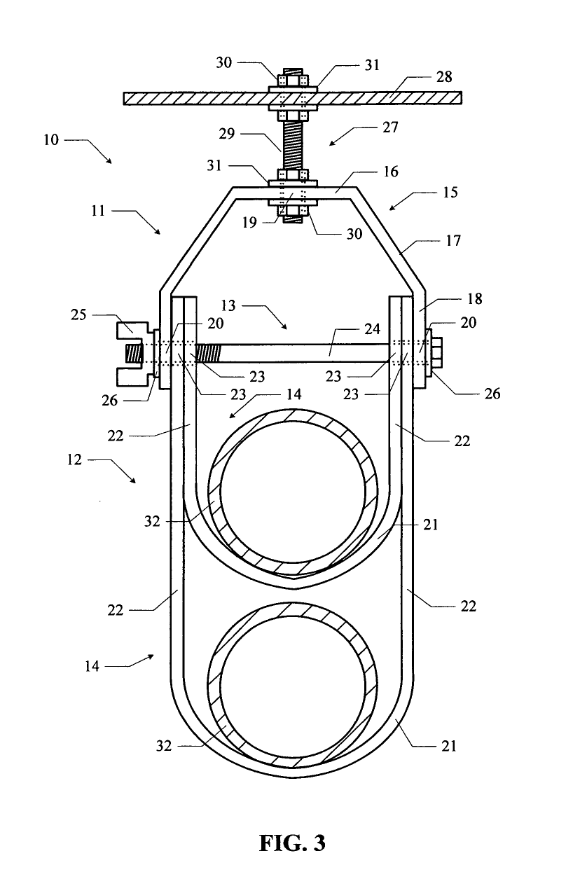

FIG. 3 is an environmental side view of the embodiment of the invention shown in FIG. 1. FIG. 3 additionally shows a holding assembly 27 connecting the multiple vertical conduit hanger 10 to a support 28 attached to a ceiling or other support (not shown). The holding assembly generally comprises a threaded rod 29 inserted through the aperture 19 in the upper portion 16 of the upper hanger member 15. In the exemplary embodiment illustrated in FIG. 3, the threaded rod 29 is securely attached to the upper portion 19 of the upper hanger member 15 by nuts 30 and washers 31. However, the method of attachment is not intended to be a limitation of the invention. Further, the threaded rod 29 could be securely attached to the support 28 by additional nuts 30 and washers 31. The lower hanger members 14 are shown carrying conduits 32. In FIG. 3, the exemplary conduits 32 are pipes, but the type of conduit is not intended to be a limitation of the invention.

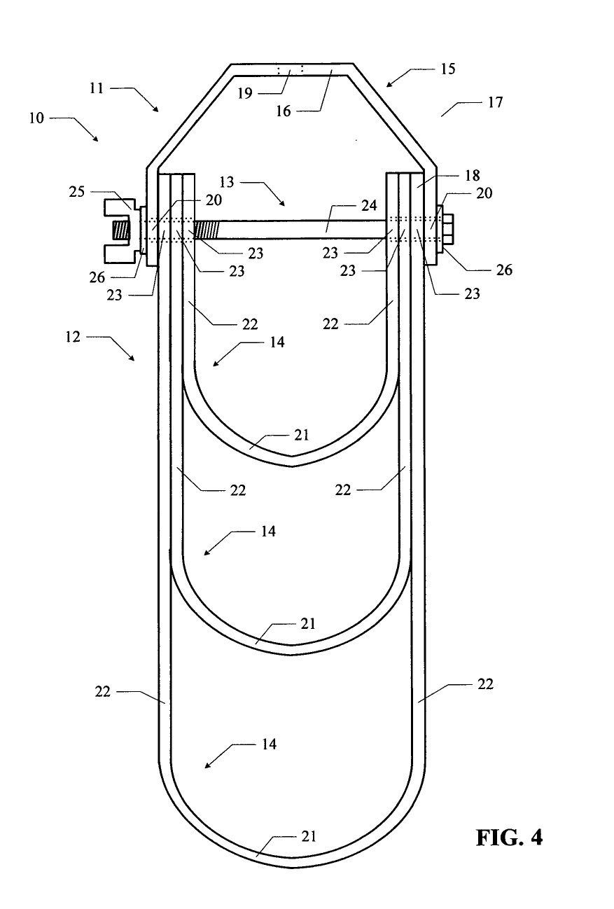

FIG. 4 is a side view of another embodiment of the invention as a multiple clevis hanger. FIG. 4 shows a lower hanger assembly 12 comprising more than two lower hanger members 14. Three lower hanger members 14 are illustrated in FIG. 4, but the number is not intended to be a limitation of the invention.

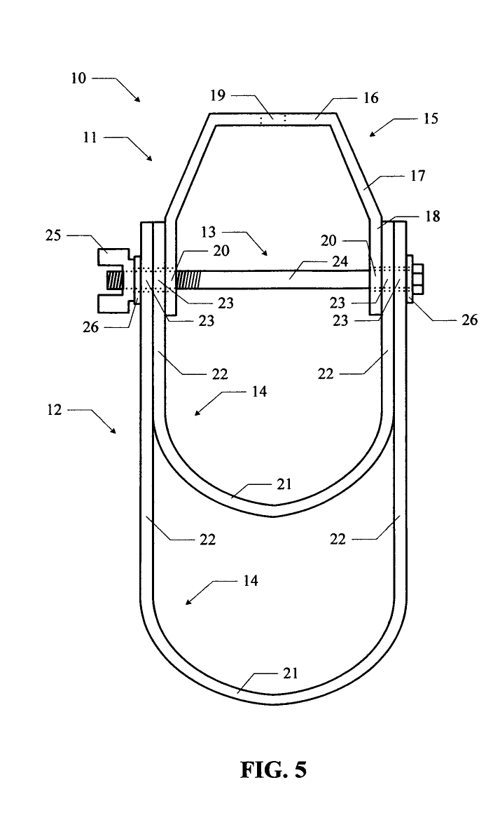

FIG. 5 is a side view of an alternative embodiment of the invention as a double clevis hanger. The lower hanger members 14 are aligned with the upper hanger member 15 in an alternative embodiment. FIG. 5 shows the two lower hanger members 14 positioned outside of the upper hanger member 15, rather than inside, as illustrated in FIG. 1.

One advantage of the multiple clevis hanger of the invention is the ability to hang two or more conduits from the same support device. Another advantage of the invention is to provide a hanger to install two or more conduits with a fraction of the labor used to install conduits in single clevis hangers by methods standard in the industry.

A further advantage of the invention is to decrease costs by the manufacture of a multiple clevis hanger for installing multiple conduits instead of having to utilize several single clevis hangers, as is conventionally done. The invention, as designed, will provide savings in manufacturing materials, manufacturing labor, and installation materials by saving, for example, the additional rods, couplings, inserts, nuts, and washers normally needed. The multiple clevis hanger of the invention can be licenced to all manufacturers of clevis hangers to enhance the use of their single clevis hangers. In one embodiment, the manufactures could produce the complete multiple clevis hanger of the invention. In an alternative embodiment, the additional lower hanger members could be manufactured to attach to existing single clevis hangers.

The invention will also save installation labor. Typically, when assembling a clevis hanger and installing a conduit, the U-shaped member is fitted around the conduit and together it is lifted up to mate with the upper hanger member, which is already connected to the support rod. These clevis hangers come with a bolt and a nut, which must be worked through the holes in all members, and then tightened with a wrench. The preferred installation procedure is to leave the multiple clevis hanger assembled, raise the conduit to the elevation of the hanger, and slide the conduit in horizontally. This procedure eliminates taking the hanger apart.

It should be understood that the preceding is merely a detailed description of specific embodiments of this invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents.

I claim:

1. A multiple clevis hanger, comprising:
an inverted, generally U-shaped upper hanger member;
a plurality of generally U-shaped lower hanger members of different lengths, wherein shorter lower hanger members are positioned within longer lower hanger members; and
a fastener to connect the upper hanger member and the plurality of lower hanger members.

2. The hanger of claim 1, wherein the upper hanger member comprises an upper portion, a pair of upper arms extending generally downward from the upper portion, and a pair of lower arms extending generally vertically downward from the upper arms, with lower ends of the lower arms horizontally aligned.

3. The hanger of claim 2, wherein each of the lower hanger member comprises an generally semi-circularly shaped lower portion and a pair of upper arms extending generally vertically upward from the lower portion, with upper ends of the upper arms horizontally aligned.

4. The hanger of claim 3, further comprising:
apertures located in each of the lower ends of the lower arms of the upper hanger members and horizontally aligned with each other; and
apertures located in each of the upper ends of the upper arms of the lower hanger members and horizontally aligned with each other,
wherein the fastener is inserted through all the apertures to connect the upper hanger member and the lower hanger members.

5. The hanger of claim 4, wherein the fastener is a bolt secured by a wing nut and nylon bushings.

6. The hanger of claim 4, wherein the fastener is a bolt secured by a wing nut and lock washers.

7. The hanger of claim 4, further comprising:
an aperture centrally located in the upper portion of the upper hanger member;
a threaded rod inserted through the aperture in the upper hanger member; and
nuts and washers securing the threaded rod to the upper hanger member.

8. The hanger of claim 7, further comprising:
nuts and washers securing the threaded rod to an upper support attached to a ceiling.
